(19) United States
(12) Patent Application Publication
(10) Pub. No.: US 2012/0056421 A1
(43) Pub. Date: Mar. 8, 2012

(54) SYSTEM AND METHOD FOR SECURING A NUT TO AN OIL PAN

(75) Inventors: Michael E. Ward, Geneva, IL (US); John H. Siegenthaler, Darlington, WI (US); Ryan P. Merrell, Batavia, IL (US); Michael J. Wiedemann, Pingree Grove, IL (US); Charles T. Ferguson, Lake in the Hills, IL (US)

(73) Assignee: ILLINOIS TOOL WORKS INC., Glenview, IL (US)

(21) Appl. No.: 13/320,083

(22) PCT Filed: May 3, 2010
(86) PCT No.: PCT/US2010/033344

§ 371 Date: Nov. 11, 2011

Related U.S. Application Data
(60) Provisional application No. 61/177,331, filed on May 12, 2009.

(51) Int. Cl. F16L 15/00; B23P 11/00; F16L 15/04

(52) U.S. Cl. 285/355; 285/390; 29/505

(57) ABSTRACT

An oil pan nut configured to be secured to an oil pan includes a hub having an upper surface configured to support a mating surface of the oil pan, and a column integrally connected to the hub. A passage is formed through the hub and the column. The column is configured to be crimped over the upper surface of the hub in order to compressively sandwich at least a portion of the mating surface of the oil pan between the crimped column and the upper surface of the hub.

### RELATED APPLICATIONS

This application relates to and claims priority benefits from U.S. Provisional Patent Application No. 61/177,331 entitled “Oil Pan Nut,” filed May 12, 2009, which is hereby incorporated by reference in its entirety.

### FIELD OF EMBODIMENTS OF THE INVENTION

Embodiments of the present invention generally relate to an oil pan nut, and more particularly, to a system and method for securing an oil pan nut to an oil pan of a vehicle, such as an automobile.

### BACKGROUND

Various vehicles, such as automobiles, utilize lubricants, such as oil, in order to ensure that the various mechanical interfaces and structures within an internal combustion engine remain in operative condition. Oil pans typically retain oil when vehicle operation ceases.

Weld nuts are usually used with respect to oil pans. A typical weld nut includes a threaded passageway that allows the removal of oil from the pan when a threaded fastener is removed from the nut.

FIG. 1 illustrates an isometric top view of a conventional weld nut 10. The weld nut 10 includes a base 12 integrally connected to a stud 14. A central, threaded passageway 16 passes through the stud 14 and the base 12. Weld nubs 18 downwardly extend from lower surfaces of the base 12. The weld nubs 18 are used to weld the weld nut 10 to an oil pan (not shown). For example, the weld nubs 18 may be welded to a top surface of an oil pan, or to an internal surface that defines an oil-retaining chamber within the oil pan.

Welding the weld nut 10 to the oil pan, however, adds time and expense to the manufacturing process. Additionally, the welding process may distort or warp portions of the oil pan itself. Distortion of the oil pan may lead to leaks. For example, the head of the drain plug bolt may improperly seat on the oil pan, thereby creating leak paths.

Additionally, it has been found that there generally is insufficient clearance within an oil pan for a standard weld nut to sit. The nut can be shortened, but, in so doing, the nut will be less robust.

### SUMMARY OF EMBODIMENTS OF THE INVENTION

Certain embodiments of the present invention provide an oil pan nut configured to be secured to an oil pan. The oil pan nut includes a hub having an upper surface configured to support a mating surface of the oil pan, and a column integrally connected to the hub. A passage is formed through the hub and the column. The column is configured to be crimped over the upper surface of the hub in order to compressively sandwich at least a portion of the mating surface of the oil pan between the crimped column and the upper surface of the hub.

The hub may include interior threaded walls defining a portion of the passage. The interior threaded walls are configured to threadably retain a threaded shaft of a drain plug.

The oil pan nut may be devoid of welding protuberances, such as weld nubs, or any other structures configured to serve as a welding interface between the oil pan nut and the oil pan.

The upper surface of the hub may include a recessed area, such as a moat, around the column.

The oil pan nut may also include a sealant disposed on one or both of outer surfaces of the column or the upper surface of the hub.

The oil pan nut may also include a sealing gasket, such as a liquid-proof rubber gasket, positioned around the column proximate the upper surface of the hub.

Certain embodiments of the present invention provide a method of securing an oil pan nut to an oil pan. The method includes positioning a mating surface of an oil pan on a support surface of a hub of the oil pan nut, crimping a cylindrical column extending from the support surface to the mating surface of the oil pan, wherein the crimping comprises folding the cylindrical column back over the mating surface of the oil pan, and compressively sandwiching the mating surface between the crimped cylindrical column and the support surface through the crimping.

The method may be devoid of welding.

The crimping may be performed using a punch tool, or an engagement head of a drain plug.

The method may also include applying a sealant to one or more of the mating surface, the support surface, or an outer surface of the cylindrical column before the crimping.

The method may also include forming a recessed area in the support surface around the cylindrical column prior to the positioning.

Certain embodiments of the present invention provide an oil pan nut configured to be secured to an oil pan. The nut includes a hub having an upper support surface configured to support a mating surface of the oil pan.

The nut also includes a column integrally connected to, and extending from, the hub. The hub and the column share a common central axis. A passage is formed through the hub and the column about the central axis. The column is configured to be crimped over the upper surface of the hub in order to compressively sandwich at least a portion of the mating surface of the oil pan between the crimped column and the upper surface of the hub. The hub and the column are devoid of structures configured for welding. That is, the nut does not include structures that serve as welding interfaces.

### BRIEF DESCRIPTION OF SEVERAL VIEWS OF THE DRAWINGS

FIG. 1 illustrates an isometric top view of a conventional weld nut.

FIG. 2 illustrates an isometric top view of an oil pan nut, according to an embodiment of the present invention.

FIG. 3 illustrates an axial cross-sectional view of an oil pan nut, according to an embodiment of the present invention.

FIG. 4 illustrates a partial axial cross-sectional view of an oil pan nut aligned with an oil pan, according to an embodiment of the present invention.

FIG. 5 illustrates a partial axial cross-sectional view of an oil pan nut being secured to an oil pan, according to an embodiment of the present invention.

FIG. 6 illustrates a partial axial cross-sectional view of an oil pan nut aligned with an oil pan, according to an embodiment of the present invention.

FIG. 7 illustrates a partial axial cross-sectional view of an oil pan nut being secured to an oil pan, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

FIG. 2 illustrates an isometric top view of an oil pan nut 20, according to an embodiment of the present invention. The nut 20 includes a hub 22 integrally connected to a cylindrical column 24 extending from an upper surface of the hub 22. The column 24 is axially aligned with the hub 22 about a central axis x. A central passage 26, which is aligned about the central axis X, is defined through the column 24 and hub 22.

Interior surfaces (now shown in FIG. 2) of the hub 22 that define lower portions of the central passage 26 are threaded and configured to receive and threadably retain a fastener (not shown). Internal surfaces of the column 24 that define upper portions of the central passage 26 may or may not be threaded.

As discussed below, the column 24 is configured to be crimped to a mating surface of an oil pan in order to securely fasten the nut 20 to the oil pan. As shown in FIG. 2, the nut 20 is devoid of weld nubs. Instead of welding, the nut 20 is crimped to the oil pan so that an edge of a mating surface of the oil pan is compressively sandwiched between the outwardly crimped column 24 and an upper surface 28 of the hub 22.

FIG. 3 illustrates an axial cross-sectional view of the oil pan nut 20. As shown in FIG. 3, the interior surfaces 30 of the hub 22 that define a lower portion of the passage 26 are threaded. However, the interior surfaces 32 of the column 24 are not threaded, as shown in FIG. 3. Optionally, the interior surfaces 32 may include threads over at least a portion thereof.

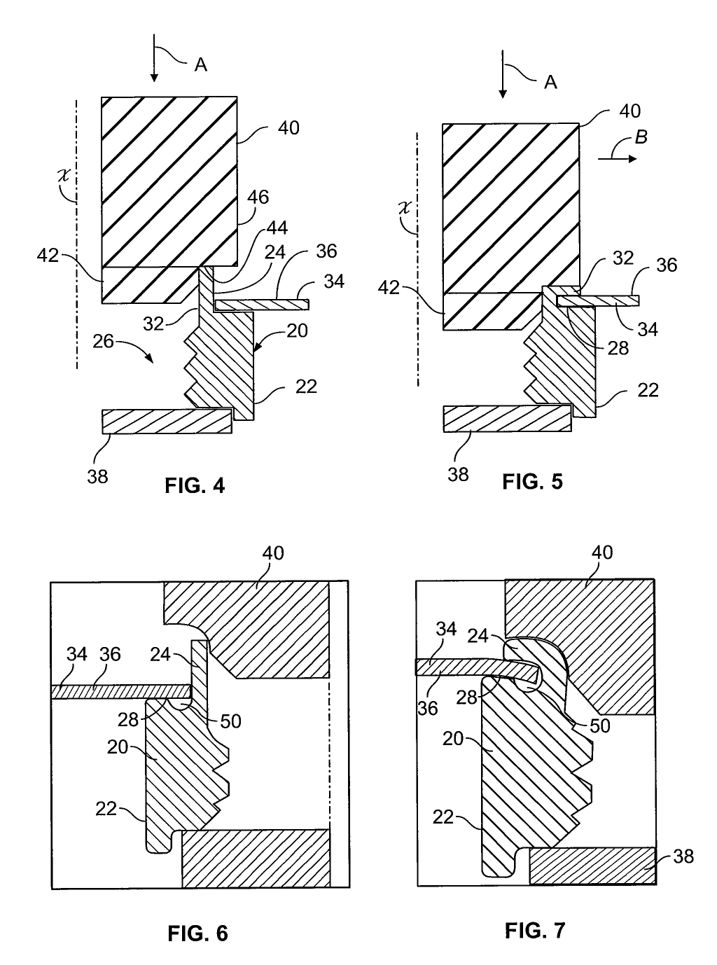

FIG. 4 illustrates a partial axial cross-sectional view of the oil pan nut 20 aligned with an oil pan 34, according to an embodiment of the present invention. For the sake of clarity, only one side of the nut 20 is shown.

In order to secure the nut 20 to the oil pan 34, a mating surface 36 of the oil pan 34 is positioned on a top surface 28 of the hub 22. While the nut 20 is shown such that the top surface 28 abuts an interior surface of the mating surface 36, the nut 20 may be positioned such that the top surface 28 abuts an exterior surface of the mating surface 36.

The hub 22 is supported by a fixed surface, such as an anvil 38. A tool 40, such as a punch, is moved toward the nut 20, such that the interior surface 32 of the column 24 abuts a reduced-diameter stud 42, while an upper edge 44 of the column 24 abuts a lower surface 46 of the main body of the tool 40. In order to securely crimp the column 24 to the oil pan 34, the tool 40 is urged toward the stationary anvil 38 in the direction of arrow A.

FIG. 5 illustrates a partial axial cross-sectional view of the oil pan nut 20 being secured to the oil pan 34. As the tool 40 is urged in the direction of arrow A, the trapped column 32 is crimped back in the direction of arrow B. As the tool 40 continues to be urged in the direction of arrow A, the column 24 folds over the mating surface 36. In this manner, the edge of the mating surface 36 is compressively sandwiched between the bent-back column 24 and the upper surface 28 of the hub 22, thereby securely fastening the nut 20 to the oil pan 34. Note, the nut 20 is secured to the oil pan 34 without any welding.

FIG. 6 illustrates a partial axial cross-sectional view of the oil pan nut 20 aligned with the oil pan 34, according to an embodiment of the present invention. FIG. 7 illustrates a partial axial cross-sectional view of the oil pan nut 20 being secured to the oil pan 34, according to an embodiment of the present invention. The nut 20 may include a recessed area 50 or moat surrounding the column 24. The recessed area 50 is formed in the upper surface 28 of the hub 22. The recessed area 50 provides a higher column 24. Further, as shown in FIG. 7, when the tool 40 is urged toward the anvil 38 to secure the nut 20 to the oil pan 34, the edge of the mating surface 36 becomes trapped within the recessed area 50, thereby providing a more robust securing attachment.

A sealant or adhesive may be disposed on the upper surface 28 of the hub 22, including the recessed area 50, and/or the outer surfaces of the column 24. The sealant and/or adhesive provides another barrier against leakage.

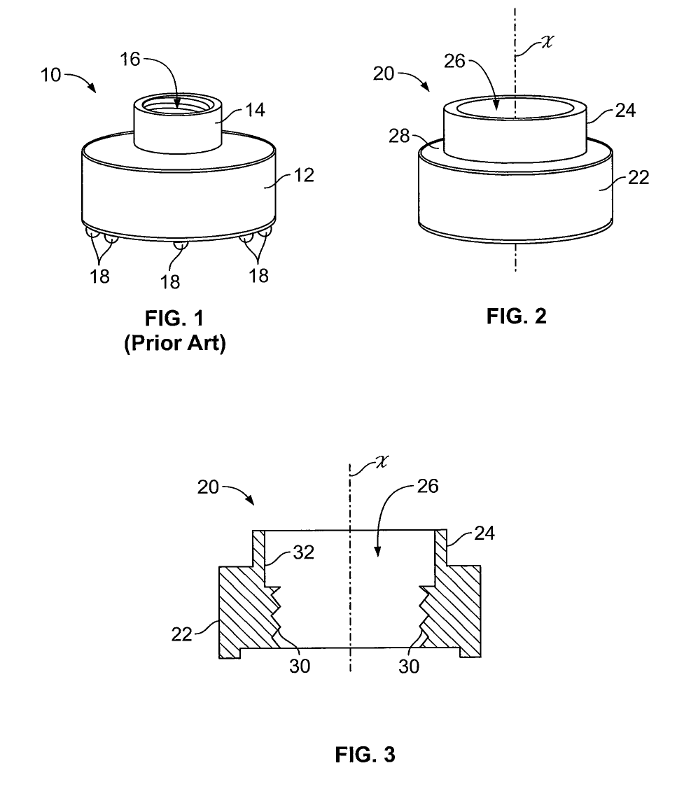

Referring to FIGS. 5 and 7, in particular, after the process of securing the nut 20 to the oil pan 34 is complete, a drain plug or fastener (not shown) may be secured into the threaded passage 26. The head of the plug/fastener seats lower with respect to the nut 20 as compared to the weld nut 20. That is, because the column 24 is crimped back, the head of the plug/fastener seats closer to the hub 22 as compared to the conventional nut 10 (shown in FIG. 1).

Alternatively, a drain plug with a large enough head may serve as the device that crimps the column 24 to the oil pan 34. That is, a head that covers the upper edges 44 of the column 24 may serve as the component that crimps the column 24 to the oil pan 34. As the drain plug/fastener threadably engages the nut 20, the head moves toward the hub 22, and crimps the column 24 in the manner described above.

Additionally, a liquid proof ring, such as a rubber gasket, may be positioned around the column 24 or recessed area 50 to provide additional sealing.

Embodiments of the present invention provide an oil pan nut 20 that may be securely fastened to an oil pan without the use of welding. Embodiments of the present invention provide a system and method of quickly and efficiently securing the oil nut 20 to an oil pan 34.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. An oil pan nut configured to be secured to an oil pan, the oil pan nut comprising:
a hub having an upper surface configured to support a mating surface of the oil pan; and
a column integrally connected to said hub, wherein a passage is formed through said hub and said column, and wherein said column is configured to be crimped over said upper surface of said hub in order to compressively sandwich at least a portion of the mating surface of the oil pan between said crimped column and said upper surface of said hub.

2. The oil pan nut of claim 1, wherein said hub comprises interior threaded walls defining a portion of said passage, wherein said interior threaded walls are configured to threadably retain a threaded shaft of a drain plug.

3. The oil pan nut of claim 1, devoid of welding protuberances.

4. The oil pan nut of claim 1, wherein said upper surface comprises a recessed area around said column.

5. The oil pan nut of claim 1, further comprising a sealant disposed on one or both of outer surfaces of said column or said upper surface of said hub.

6. The oil pan nut of claim 1, further comprising a sealing gasket positioned around said column proximate said upper surface of said hub.

7. The oil pan nut of claim 6, wherein said sealing gasket is formed of rubber.

8. A method of securing an oil pan nut to an oil pan, the method comprising:
positioning a mating surface of an oil pan on a support surface of a hub of the oil pan nut;
crimping a cylindrical column extending from the support surface to the mating surface of the oil pan, wherein said crimping comprises folding the cylindrical column back over the mating surface of the oil pan; and
compressively sandwiching the mating surface between the crimped cylindrical column and the support surface through said crimping.

9. The method of claim 8, devoid of welding.

10. The method of claim 8, wherein said crimping is performed using a punch tool.

11. The method of claim 8, wherein said crimping is performed using a drain plug head.

12. The method of claim 8, further comprising applying a sealant to one or more of the mating surface, the support surface, or an outer surface of the cylindrical column before said crimping.

13. The method of claim 8, further comprising forming a recessed area in the support surface around the cylindrical column prior to said positioning.

14. An oil pan nut configured to be secured to an oil pan, the oil pan nut comprising:
a hub having an upper support surface configured to support a mating surface of the oil pan; and
a column integrally connected to, and extending from, said hub, wherein said hub and said column share a common central axis, wherein a passage is formed through said hub and said column, wherein said column is configured to be crimped over said upper surface of said hub in order to compressively sandwich at least a portion of the mating surface of the oil pan between said crimped column and said upper surface of said hub, and wherein said hub and said column are devoid of structures configured for welding.

15. The oil pan nut of claim 14, wherein said hub comprises interior threaded walls defining a portion of said passage, wherein said interior threaded walls are configured to threadably retain a threaded shaft of a drain plug.

16. The oil pan nut of claim 14, wherein said upper support surface comprises a recessed area around said column.

17. The oil pan nut of claim 14, further comprising a sealant disposed on one or both of outer surfaces of said column or said upper surface of said hub.

18. The oil pan nut of claim 14, further comprising a sealing gasket positioned around said column proximate said upper surface of said hub.

19. The oil pan nut of claim 18, wherein said sealing gasket is formed of rubber.
